(19) United States
(12) Patent Application Publication
(10) Pub. No.: US 2026/0270854 A1
(43) Pub. Date: Sep. 10, 2026

(54) ACCESS POINT DISCOVERY IN ENHANCED PRIVACY WIRELESS NETWORKS

(71) Applicant: Cisco Technology, Inc., San Jose, CA (US)

(72) Inventors: Domenico FICARA, Essertines-Sur-Yverdon (CH); Ugo M. CAMPIGLIO, Morges (CH); Federico LOVISON, Fontanelle (IT); Jerome HENRY, Pittsboro, NC (US); Javier I. CONTRERAS ALBESA, Sant Cugat del Valles (ES)

(21) Appl. No.: 19/557,494

(22) Filed: Mar. 5, 2026

Related U.S. Application Data
(60) Provisional application No. 63/769,601, filed on Mar. 10, 2025.

(51) Int. Cl. H04W 48/16

(52) U.S. Cl. CPC H04W 48/16

(57) ABSTRACT

The present disclosure provides techniques for identifying and transmitting future Basis Service Set identifiers (BSSIDs) for access points (APs) in an Extended Service Set (ESS), including implementing, by a first AP, a BSS for one or more wireless stations, where an ESS includes the first AP and a second AP neighboring the first AP, and where the second AP is a basic service set privacy enhancements (BPE) AP. The first AP may encode a wireless management frame including a neighbor report element for the second AP, where the neighbor report element includes data indicating a basic service set identifier (BSSID) for one or more next epochs. Further, the wireless management frame may be transmitted by the first AP to a wireless station of the BSS.

### CROSS-REFERENCE TO RELATED APPLICATIONS

This application claims benefit of co-pending U.S. provisional patent application Ser. No. 63/769,601 filed Mar. 10, 2025. The aforementioned related patent application is herein incorporated by reference in its entirety.

### TECHNICAL FIELD

Embodiments presented in this disclosure generally relate to wireless networks. More specifically, embodiments disclosed herein relate to identifying enhanced-security wireless devices.

### BACKGROUND

Modern wireless networks may employ a number of security features aimed at enhancing the security of the network and its clients. Basic Service Set (BSS) privacy enhancements (BPE) enable various BSSs to preserve privacy and avoid outside tracking of the network, such as through attempting to anonymize BSS identifiers (BSSIDs) by periodically changing the BSSID of wireless access points (APs). However, stations (STAs) looking for neighboring APs in an Extended Service Set (ESS) may be unable to locate a previously identified AP, due to the changing BSSIDs throughout the network.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example environment for wireless network management, according to some embodiments of the present disclosure.

FIG. 2 depicts an example environment for identifying neighboring BSSID information, according to some embodiments of the present disclosure.

FIG. 3 depicts an example format for signaling neighboring BSSID information, according to some embodiments of the present disclosure.

FIG. 4 is a flow diagram depicting an example method for transmitting neighboring BSSID information to a requesting station, according to some embodiments of the present disclosure.

FIG. 5 is a flow diagram depicting an example method for identifying neighboring identification information, according to some embodiments of the present disclosure.

FIG. 6 is a flow diagram depicting an example method for identifying neighboring BSSID information, according to some embodiments of the present disclosure.

FIG. 7 depicts an example computing device configured to perform various embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method. The method includes: implementing, by a first access point, a basic service set (BSS) for one or more wireless stations, wherein an Extended Service Set (ESS) includes the first access point and a second access point neighboring the first access point, and wherein the second access point is a basic service set privacy enhancements (BPE) access point; encoding, by the first access point, a wireless management frame including a neighbor report element for the second access point, wherein the neighbor report element includes data indicating a basic service set identifier (BSSID) for one or more next epochs; and transmitting, by the first access point, the wireless management frame to a wireless station of the BSS.

Other embodiments provide an access point comprising one or more memories and one or more processors communicatively coupled to the one or more memories, wherein the one or more processors are configured to, individually or collectively, perform the aforementioned method, as well as those described herein; and a non-transitory computer readable storage medium comprising instructions that when executed configure one or more processors of an access point to perform the aforementioned methods as well as those described herein.

### Example Embodiments

In some embodiments of the present disclosure, techniques are provided to identify BSSID information of neighboring APs in an Extended Service Set featuring one or more BPE-enabled APs.

Many wireless deployments are comprised of Basic Service Sets, each comprising one AP and various wireless STAs connected to the AP. An Extended Service Set connects multiple BSSs together, in turn comprising multiple APs from across the connected BSSs. In this way, wireless STAs may be able to roam between different BSSs of the ESS without losing connectivity.

In order to roam, STAs may transmit a Neighbor Report Request to its current AP (e.g., the AP of the STA's current BSS). In traditional networks, a BSS may respond with a Neighbor Report Response including a Neighbor Report element, which includes information related one or more neighboring APs (e.g., APs of neighboring BSSs in the same ESS as the STA), such as the BSSID of a neighboring AP.

However, in modern BPE-enabled networks, BSSIDs may periodically change (e.g., at a random or set frequency) in an attempt to anonymize the network and prevent identification and tracking of the AP(s) and client(s) by outside actors. While this may result in increased security for the network, traditional Neighbor Report elements are incapable of providing sufficient information for requesting STAs to roam effectively, as the BSSID(s) identified in the Neighbor Report Response may be outdated by the time a STA attempts to connect or roam (e.g., if the AP is BPE-enabled).

Embodiments of the present disclosure provide methods, systems, and apparatuses for providing future BSSIDs of neighboring APs throughout an ESS to STAs. More specifically, some embodiments are directed towards techniques enabling a network device (e.g., an AP) to identify future BSSIDs across one or more future epochs (e.g., time periods) and transmit the future BSSID information in a Neighbor Report element to a requesting STA. Such techniques enable an ESS to benefit from the enhanced privacy and security offered by BPE without facing connectivity issues associated with roaming across various BSSs.

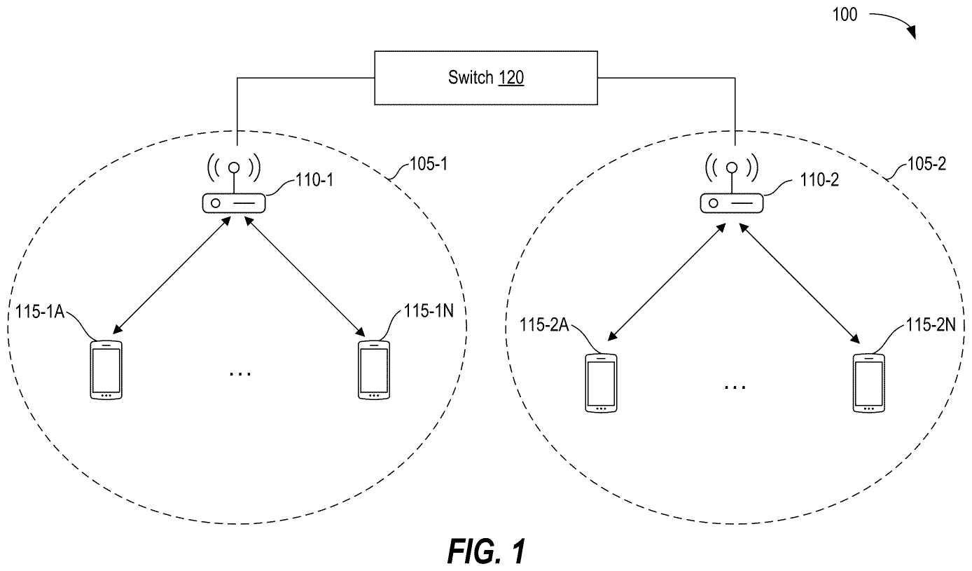

FIG. 1 depicts an example wireless environment 100 in which embodiments of the present disclosure may be implemented. As depicted, the environment 100 includes multiple Basic Service Sets 105-1 and 105-2 (collectively, “BSSs 105”), connected by a switch 120 to form an Extended Service Set. Although the Extended Service Set of FIG. 1 is depicted as including only two BSSs, any number of BSSs may be included in other implementations.

Each of the BSSs 105 may include an AP, such as an AP 110-1 and an AP 110-2 (collectively, “APs 110”). Each AP 110 may generally correspond to an access point used to facilitate or provide connectivity in a wireless network (e.g., a wireless local area network (WLAN), e.g., using Wi-Fi protocols) and implement a BSS. Each respective AP 110 may be identified throughout the ESS with a respective unique BSSID, which wireless STAs may use to connect to and send data throughout a corresponding BSS.

Each of the APs 110 may be configured to provide wireless access to one or more wireless STAs (e.g., client devices), such as a collection of STAs 115-1A through STAs 115-1N or a collection of STAs 115-2A through STAs 115-2N (collectively, “STAs 115”). Each of STAs 115 may generally be representative of any computing device capable of wireless communications using the WLAN, such as a smartphone, tablet, laptop, wearable computing device (e.g., smartwatch), and the like.

Each of the APs 110 may be associated with any number of the associated set of STAs 115 for active wireless data communications. For example, as depicted, the STA 115-1A is associated with the AP 110-1. In some embodiments, each of the APs 110 may be concurrently connected to any number of client devices. In some embodiments, each AP 110 may operate as a single-link AP or as a multi-link device (MLD) AP, and each STA 115 may operate as a single-link station (STA) or as an MLD STA.

In some embodiments, any (or all) of the APs 110 may be a BPE-capable AP, such that the AP is capable of implementing BSS privacy enhancement techniques, such as changing BSSIDs periodically. For example, the AP 110-1 may be a BPE-capable AP, with a first BSSID at a first time. The AP 110-1 may be configured to change BSSIDs periodically (e.g., every ten minutes, every hour, every day, etc.), such that at a second time, the AP 110-1 may stop using the first BSSID to begin using a second BSSID, the second BSSID different (e.g., unique from) than the first BSSID.

Any of the STAs 115 may communicate with an associated AP to request and/or receive information related to a neighboring AP in the ESS. As one example, the STA 115-1A may transmit a Neighbor Report Request to the AP 110-1 to identify information about surrounding APs and identify an AP to reassociate with (e.g., to roam to). In response, the AP 110-1 may transmit a Neighbor Report Response to the STA 115-1A. In conventional systems, the Neighbor Report Response may include a Neighbor Report Element including information, such as a current and/or permanent BSSID, for the AP 110-2. However, the APs 110, using embodiments of the present disclosure, may generate a Neighbor Report Element including one or more additional fields, such as one or more future BSSIDs for one or more BPE-enabled APs of the ESS or the time at which said BSSIDs will be used. That is, in the present example, the Neighbor Report Element generated and/or transmitted by the AP 110-1 may include one or more future BSSIDs for the AP 110-2 (e.g., BSSIDs that the AP 110-2 will use at a future time).

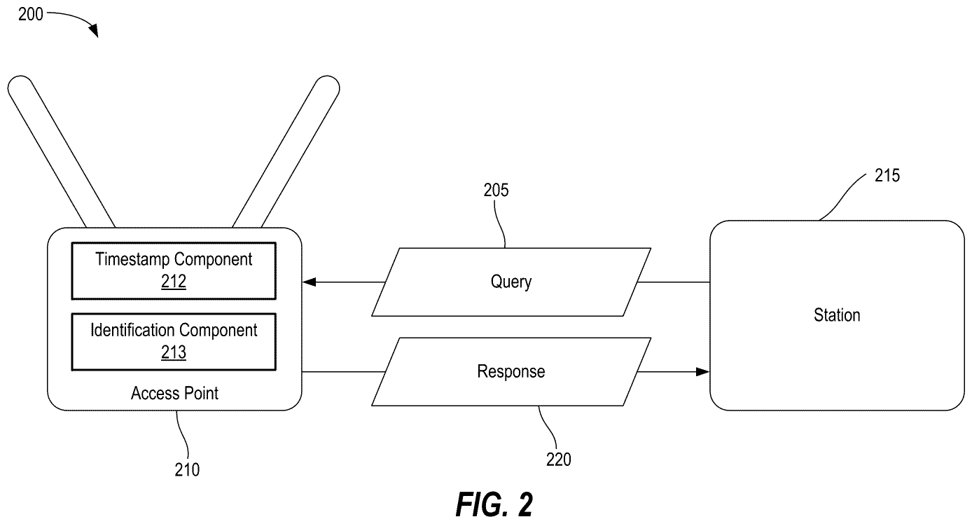

FIG. 2 depicts an example environment 200 for identifying neighboring BSSID information, according to some embodiments of the present disclosure. In the illustrated example, an AP 210 (which may correspond to one of the APs 110 of FIG. 1) is communicatively coupled with a STA 215 (which may correspond to one of the STAs 115 of FIG. 1), such as via a WLAN (e.g., a Wi-Fi network). That is, the AP 210 and the STA 215 may correspond to any of the APs 110 of FIG. 1 and an associated STA of the STAs 115, respectively, such that the AP 210 and the STA 215 may be a part of the same BSS, which in turn may be a part of a larger ESS.

In the environment 200, the STA 215 transmits a query 205 to the AP 210. For example, the STA 215 may transmit the query 205 via an action frame, or other non-routable data frame. The query 205 may generally correspond to, or comprise, a request for the AP 210 to provide information to the STA 215 about any neighboring APs in the same ESS as the AP 210 (e.g., the AP 110-2 of FIG. 1). For example, the query 205 may be, or may comprise, a BSS Transition Management Query, an Access Network Query Protocol Request, or a Neighbor Response Request. In response to receiving the query 205, the AP 210, in conjunction with a timestamp component 212 and an identification component 213, may determine a future BSSID for one or more neighboring APs of the AP 210.

The timestamp component 212 may determine a current epoch associated with a neighboring AP. The timestamp component 212 may also determine one or more next epochs or times at which the current BSSID of the neighboring AP may change to a new BSSID. For example, the timestamp component 212 may determine that an epoch for a neighboring AP is ninety seconds, and that, at the end of each ninety seconds, the neighboring AP will change from the current BSSID to a future BSSID. In some examples, such as when a neighboring AP is not BPE-capable or BPE-enabled, the timestamp component 212 may refrain from determining an epoch associated with the neighboring AP, since the BSSID of said AP would remain the same.

The identification component 213 may use the epoch information determined by the timestamp component 212 to determine a current BSSID for a neighboring AP, alongside one or more future BSSIDs for said AP for one or more next epochs (e.g., at the subsequent epoch, at the fourth epoch from the current epoch, etc.). For example, the identification component 213 may be configured to identify a future BSSID for a neighboring AP from a database (e.g., a list, table, etc.) of future BSSIDs for one or more APs across the ESS. As another example, the identification component 213 may be configured to apply a hash function to the current BSSID of the neighboring AP to determine a future BSSID of the neighboring AP.

The AP 210 may encode one or more wireless management frames, wherein the management frame includes a neighbor report element associated with a neighboring AP. The AP 210 may include a BSSID for the neighboring AP for one or more next epochs in the neighbor report element. In some examples, additional information determined by the timestamp component 212 and/or the identification component 213, such as a current BSSID or epoch, may also be included in the neighbor report element, or included separately in the wireless management frame. The AP 210 may transmit the wireless management frame to the STA 215 as, or as part of, the response 220.

Although the illustrated example depicts the STA 215 providing the query 205 to the AP 210, in some embodiments, the AP 210 may be configured to transmit future BSSID data to the STA 215 unprompted (e.g., without receiving the query 205). For example, the AP 210 may transmit an unsolicited load balancing request as part of one or more BSS Transition Management techniques (e.g., to suggest that the STA 215 connect to a less trafficked AP). The AP 210 may provide the STA 215 with a neighboring AP's BSSID for the current epoch and one or more next epochs, such that the STA 215 may use the suggestion and included information to roam to the new AP.

In some examples, the query 205 may include a number of epochs, a time period, and/or time stamps for which the AP 210 should provide a future BSSID. For example, the STA 215 may specify in the query 205 that the AP 210 should provide information over the next three epochs. In response, the identification component 213 may determine the future BSSID at each of the next three epochs, and the AP 210 may include each BSSID in the response 220. As another example, the STA 215 may specify in the query 205 that the AP 210 should provide information applicable at a time five minutes from the current time. In response, the timestamp component 212 may determine what the epoch will be, or how many epochs would have passed, at the identified time. The timestamp component 212 may provide this information to the identification component 213, which may determine a future BSSID for neighboring AP(s) at the identified future time. The AP 210 may include the BSSID(s) in the response 220.

In some embodiments, the query 205 may include a request for BPE-capable or non-BPE capable APs. For example, the STA 215 may request (e.g., in the query 205) that the AP 210 provide information on all neighboring APs, regardless of whether an AP is BPE-capable or not. In another example, the STA 215 may request that the AP 210 only provide information on BPE-capable APs, while in yet another example, the STA 215 may request that the AP 210 only provide information on non-BPE capable APs.

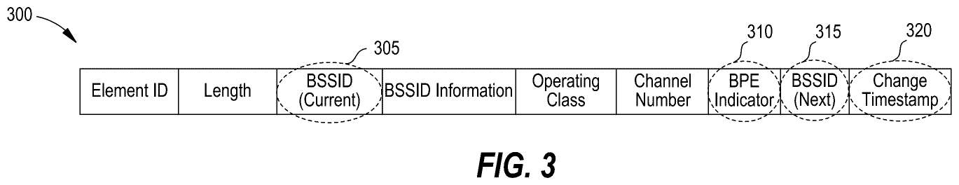

FIG. 3 depicts an example format for signaling current and future BSSID information using one or more separate fields, according to some embodiments of the present disclosure.

As depicted, an example format 300 illustrates signaling of a neighbor report element. In the example format 300, a current BSSID (e.g., the BSSID of a neighboring AP at a current time or current epoch) may be included in a BSSID (Current) field 305 of the neighbor report element. An indicator of whether or not the identified AP is BPE-capable and/or BPE-enabled may be included in a BPE Indicator field 310. One or more future BSSID(s) may be included in a BSSID (Next) field 315. Epoch information, such as the timestamp(s) of one or more next epoch(s) at which point a future BSSID will be used, may be included in a Change Timestamp field 320.

In the example format 300, any of the fields referenced may be one or more bits in length. Additionally, any of the fields referenced may be variable in length, such that a field may have a different length in one transmission than in a separate transmission. For example, the BSSID (Next) field 315 may be variable size, such that in one example, the field may hold one future BSSID, while in another example, the field may include multiple future BSSIDs (e.g., across multiple future time periods or at multiple subsequent epochs).

Additionally, different types of information by be indicated using different encoding mechanisms. For example, a single bit may be used to distinguish between BPE-capable or non BPE-capable APs (e.g., using a one-bit indicator as the BPE Indicator field 310). However, other encodings, including reserved or extensible values, may also be used. An AP (e.g., one of the APs 110 of FIG. 1 or the AP 210 of FIGS. 1 and 2, respectively), may signal the future BSSID information of neighboring APs using the fields illustrated in FIG. 3. Such signaling may be included in one or more management frames, such as beacon frames, probe response frames, (re)association response frames, or other broadcast or unicast management frames.

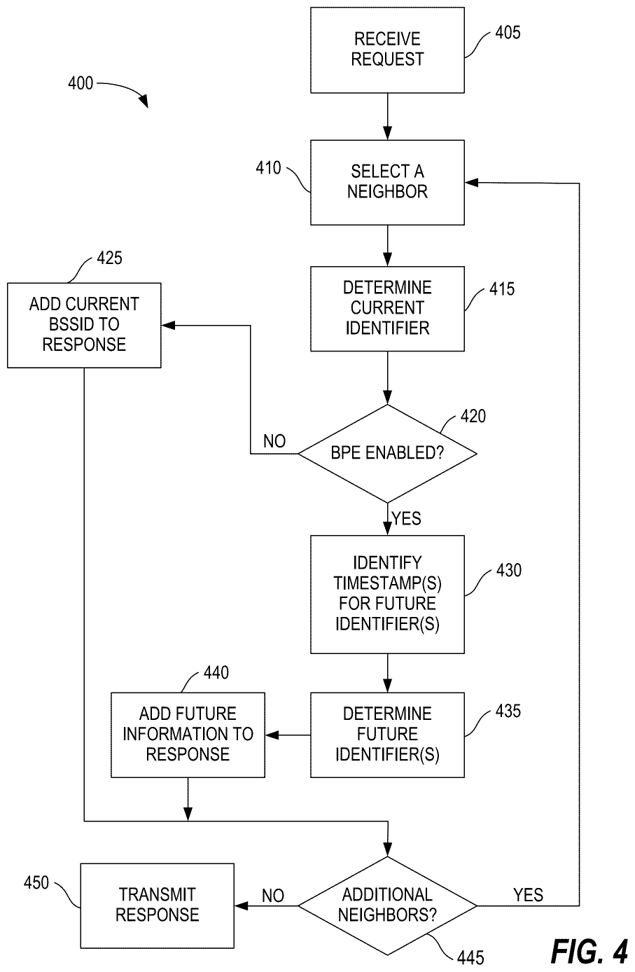

FIG. 4 depicts an example method 400 for transmitting neighboring BSSID information to a requesting station, according to some embodiments of the present disclosure. The example method 400 may be performed by an AP, such as one of the APs 110 of FIG. 1 or the AP 210 as depicted in FIG. 2.

At block 405, the AP (e.g., one of the APs 110 of FIG. 1 or the AP 210 as depicted in FIG. 2) receives a request from a wireless STA (e.g., one of the STAs 115 of FIG. 1 or the STA 215 of FIG. 2). More specifically, the AP may receive a non-routable data frame comprising a request for information on one or more neighboring AP devices (e.g., AP devices in a neighboring BSS). For example, at block 405, the AP may receive a BSS Transition Management Query, an Access Network Query Protocol Request, or a Neighbor Response Request.

At block 410, the AP selects a neighboring AP device (e.g., one of the APs 110 of FIG. 1 residing in a different BSS 105 than the AP performing the action) to analyze. The AP may generally select the neighboring AP at block 410 using a wide variety of techniques, including randomly or pseudo randomly. In some examples, the AP may select a neighboring AP device based on one or more network conditions related to a candidate AP, such as signal strength, number of currently connected clients, or the like. In some examples, the AP device may choose from any number of available APs within the same network (e.g., the ESS) of the AP device. In other examples, the list of AP devices may be limited by one or more factors. For instance, in some examples, the request received at block 405 may include a list of neighboring APs for which the receiving AP should analyze. As one example, the requesting device may provide a list of current BSSIDs for which the AP should identify future BSSIDs. For example, a STA may scan one or more wireless channels and identify one or more channels on which a BPE-enabled AP of the ESS sends a Privacy Beacon. The STA may include information, such as the channel and current BSSID of the AP, in the request as a targeted neighbor report request, such that the AP device only analyzes the neighboring AP devices associated with the provided BSSID(s).

As another example, the request may specify that the AP device should only provide information for APs of certain security types (e.g., whether that are BPE-enabled, BPE-capable, non-BPE enabled, etc.). In other examples, the AP device itself may limit the number of neighboring AP devices analyzed, based on one or more factors (e.g., transmission size, network conditions such as signal strength or number of clients, etc.).

At block 415, the AP device determines the current BSSID for the selected neighboring AP. In some examples, the AP device may maintain a local (e.g., on-device) list with information relating to the selected neighboring AP, such as the BSSID, operating class, and/or channel number, as depicted in FIG. 3. In such examples, the AP device may query the table to determine the current BSSID. In other examples, the AP device may interact with (e.g., query) one or more other network devices to retrieve or otherwise determine information relating to the selected neighboring AP. For example, the AP device may query the controller for the wireless network (e.g., the wireless LAN controller (WLC)), which may be responsible for storing or otherwise managing such information. The WLC may, in response, provide information, such as the current BSSID, to the AP device.

At block 420, the AP device determines whether the neighboring AP device is BPE-enabled. That is, the AP device determines whether the selected neighboring AP device has BSS privacy enhanced capabilities enabled (e.g., turned on), such that the BSSID of the selected device is configured to change over time.

If the selected device is not BPE-enabled (e.g., the AP device does not have the capability to implement BPE techniques, the AP device is configured to not operate according to BPE techniques, etc.), the AP device is configured to proceed to block 425, according to the “NO” branch of block 420. At block 425, the AP devices adds the current BSSID of the selected AP device to the response. For example, the AP device may include the current BSSID in the response, such as by using the BSSID (Current) field 305 of the example format depicted by FIG. 3. In some embodiments, a flag used to indicate BPE capability (e.g., the BPE Indicator field 310 of FIG. 3) for the neighboring AP may also be set accordingly to indicate that the selected neighbor does not currently implement BPE. The AP device then proceeds to block 445 (discussed below) to determine if there are additional neighbors to analyze.

If the selected neighboring AP is BPE-enabled, the AP device is configured to proceed to block 430, according to the “YES” branch of 420. At block 430, one or more components of the AP device (e.g., the timestamp component 212 of FIG. 2) identifies one or more timestamps at which the selected neighboring AP device will change from one BSSID to a different BSSID (e.g., current BSSID to a subsequent, future BSSID). In some examples, the timestamp(s) may be relative, such as representing how epochs or how much time will pass before a future identifier is to begin being used by the selected neighbor with respect to a current time, a time starting from the transmission of the response in block 450 (discussed below), or the like. In other examples, the timestamp may be an absolute time indicating when the change will occur (e.g., based on a current time synchronization function (TSF) of the AP device).

In additional examples, the timestamp(s) may be determined based on information included in the request received at block 405. For example, a requesting device (e.g., the STA 215 of FIG. 2) may request the future BSSIDs at, or up to, a specified amount of time. In some examples, the requested time may be in absolute terms (e.g., “provide the future BSSIDs at the following time”), while in other examples, the requested time may be relative (e.g., “provide the future BSSIDs available for the next 10 seconds” or “provide the future BSSIDs available 30 seconds from now”).

In some examples, the AP device may identify the timestamp(s) based on local information stored by the AP device, while, in other examples, the AP device may identify the information as a result of one or more queries to another network device, such as the WLC, as discussed above with respect to block 415. Accordingly, in some examples, the AP device, or one or more components in communication with the AP device (e.g., the WLC) may already know an epoch at which an identifier changes, for the selected neighboring AP. In other examples, one or more future epochs may not yet be known or determined, and may be identified on demand (e.g., by the AP device, the WLC, etc.).

At block 435, one or more components of the AP device (e.g., the identification component 213 of FIG. 2) determines one or more future BSSIDs for the selected neighboring AP device. In some examples, the AP device may be configured to identify a specific number of future BSSIDs (e.g., across a specific number of time periods or epochs). In some examples, the number of future BSSIDs that the AP device may be determined by the AP device (e.g., dynamically, pre-configured/static, etc.). In some examples, the number of future BSSIDs may be indicated as a part of the initial request received at block 405. For example, the request may specify that the AP device should provide BSSIDs for a neighboring AP device for the next three epochs. In response, the AP device may determine the future BSSID at each of the next three epochs.

In some examples, the AP device may identify the future BSSID(s) based on local information stored by the AP device, while, in other examples, the AP device may identify the information as a result of one or more queries to another network device, such as the WLC, as discussed above with respect to blocks 415 and 430. For example, the AP device may access, interact with, or otherwise query frame anonymization parameter data of the neighboring AP device, which may store BSSID information for the neighboring device (e.g., a function used to determine future BSSIDs, a list of pre-determined future BSSIDs, as discussed below, etc.).

In some examples, the AP device, or one or more components in communication with the AP device (e.g., the WLC) may already know one or more future BSSIDs for the selected AP. For example, the future BSSIDs across the next ten epochs may be calculated for fast retrieval and identification. In other examples, the one or more future BSSIDs may not yet be known or determined, and may be calculated on demand (e.g., by the AP device, the WLC, etc.). For example, the AP device may be configured to apply a hash function to the current BSSID to determine a future BSSID. In other examples, in addition to or instead of determining the future BSSIDs, the AP device may be configured to provide the hash function (or other algorithm used to define future BSSIDs), along with any relevant additional parameters (such as a pseudo-random number generation seed), to the STA, which may be configured to use the function and parameters to determine the future BSSID(s).

At block 440, the AP devices adds the future information (e.g., information related to the one or more future BSSIDs) to the response. For example, at block 440, the AP device may add an indicator indicating that the neighboring AP device in question is BPE-enabled, such as in the BPE Indicator field 310 of the example format depicted in FIG. 3. Similarly, the AP device may add each of the future BSSIDs identified, and their corresponding timestamps, as the BSSID (Next) field 315 and the Change Timestamp field 320, respectively. In some examples, the AP device may also include one or more Identity Keys for a neighboring BSS, which may be necessary for the STA to receive and identify neighbor beacons (e.g., Privacy Beacons, as discussed above), alongside information associated with the Identity Key(s), such as a validity period for the key.

At block 445, the AP device determines whether there are additional neighboring AP devices to analyze. For example, the AP device may determine whether to analyze additional neighboring AP devices based on various factors, such as a number or pre-defined list of requested APs by the wireless STA, network conditions of the remaining APs (e.g., signal strength, number of currently connected clients, etc.), or other similar factors. If the AP device determines that there are additional neighboring AP devices to analyze, the AP device proceeds according to the “YES” branch and returns to the selection process defined at block 410. If the AP device determines that there are no remaining neighboring AP devices left to analyze, the AP device proceeds according to the “NO” branch and transmits the response back to the requesting device at block 450. To transmit the response to the requesting device, the AP device may encode one or more wireless management frames, wherein the management frame includes a neighbor report element associated with a neighboring AP. Although the illustrated example depicts an iterative process for conceptual clarity (e.g., where the AP evaluates each neighboring AP sequentially), in some aspects, the method may evaluate some or all of the neighboring APs entirely or partially in parallel.

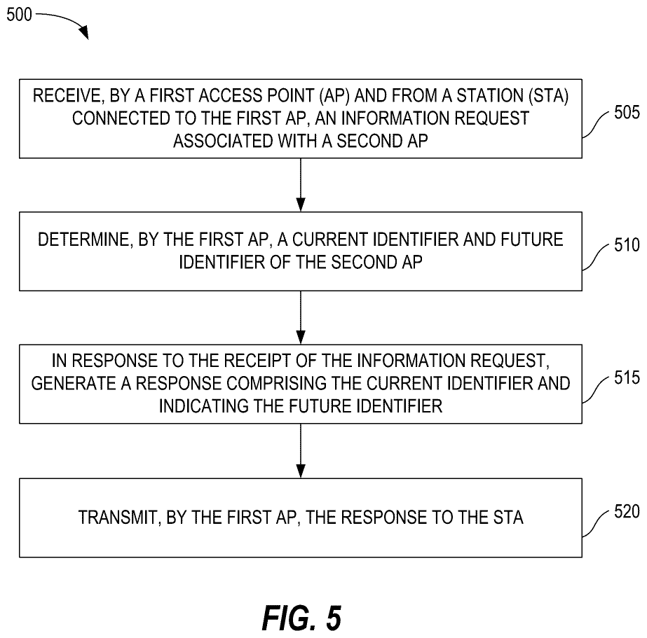

FIG. 5 Is a block diagram depicting an example method 500 for determining and transmitting future identification information, according to some embodiments of the present disclosure. In some aspects, the method 500 is performed by an AP, such as an AP 110 of FIG. 1 and/or an AP 210 of FIG. 2.

At block 505, a first access point (e.g., any of the APs 110 of FIG. 1 and/or the AP 210 of FIG. 2) receives, from a station (e.g., any of the STAs 115 of FIG. 1 and/or the STA 215 of FIG. 2) connected to the first AP, an information request (e.g., the query 205 of FIG. 2) associated with a second AP.

At block 510, the first AP determines a current identifier (e.g., the current BSSID) and a future identifier (e.g., one or more future BSSIDs) of the second AP.

At block 515, in response to the receipt of the information request, the first AP generates a response (e.g., the response 220 of FIG. 2) comprising the current identifier (e.g., using the BSSID (Current) field 305 of FIG. 3) and indicating the future identifier (e.g., using the BSSID (Next) field 315 of FIG. 3).

At block 520, the first AP transmits the response to the station.

In some embodiments, the operation of determining the current identifier and the future identifier comprises determining the current identifier of the second AP; and applying a hash function to the current identifier to determine the future identifier.

In some embodiments, the operation of generating the response further comprises: identifying a timestamp indicating when the second AP will use the future identifier; and adding the timestamp to the response (e.g., using the Change Timestamp field 320 of FIG. 3).

In some embodiments, the information request specifies the second AP.

In some embodiments, wherein the information request comprises a request number of future identifiers for the first AP to provide, the first AP generates a set of future identifiers for the second AP, wherein the size of the set is based on the requested number of future identifiers, each respective identifier of the set of future identifiers associated with a respective timestamp. The first AP then transmits a second response comprising the set of future identifiers (e.g., all included in the BSSID (Next) field 315 of FIG. 3) to the STA.

In some embodiments, the operation of generating the response includes adding a hash function used to generate the future identifier to the response.

In some embodiments, the response further comprises an identity key associated with the second AP.

In some embodiments, wherein the information request includes a requested time, the first AP determines a set of future identifiers that will be used by the second AP until the requested time. The first AP then adds the set of future identifiers to the response.

In some embodiments, the response includes a basic service set privacy enhancement (BPE) enablement status indicator for the second AP, and at least one of the first AP or the second AP is a BPE AP.

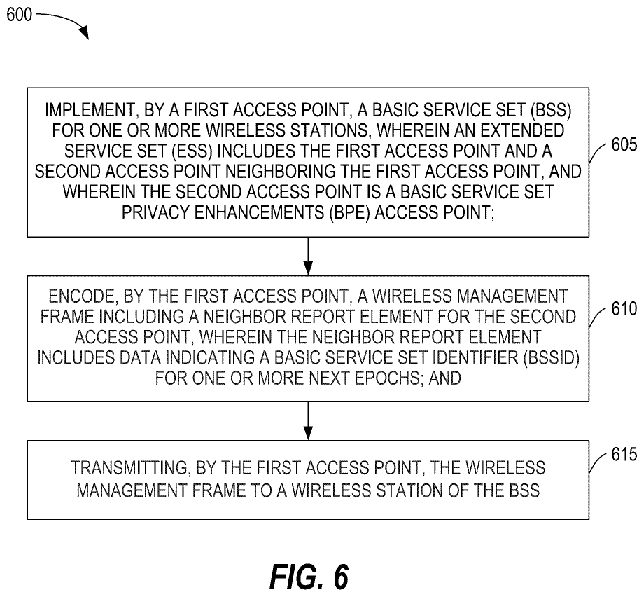

FIG. 6 is a block diagram depicting an example method 600 for encoding and transmitting future BSSID information, according to some embodiments of the present disclosure. In some aspects, the method 600 is performed by an AP, such as an AP 110 of FIG. 1 and/or an AP 210 of FIG. 2.

At block 605, a first access point (e.g., any of the APs 110 of FIG. 1 and/or the AP 210 of FIG. 2) implements a basic service set (BSS) (e.g., any of the BSSs 105 of FIG. 1) for one or more wireless stations (e.g., any of the STAs 115 of FIG. 1 and/or the STA 215 of FIG. 2), wherein an Extended Service Set (ESS) includes the first access point and a second access point (e.g., any of the APs 110 of FIG. 1 residing in a different BSS 105 than the first access point) neighboring the first access point, and wherein the second access point is a basic service set privacy enhancements (BPE) access point.

At block 610, the first access point encodes a wireless management frame (e.g., the response 220 of FIG. 2) including a neighbor report element (e.g., encoded according to the example format 300 of FIG. 3) for the second access point, wherein the neighbor report element includes data indicating a basic service set identifier (BSSID) for one or more next epochs (e.g., using the BSSID (Next) field 315 and/or the Change Timestamp field 320 of FIG. 3).

At block 615, the first access point transmits the wireless management frame to a wireless station (e.g., any of the STAs 115 of FIG. 1 residing in the same BSS 105 as the first access point) of the BSS.

In some embodiments, the neighbor report element includes data indicating a BSSID for a current epoch (e.g., using the BSSID (Current) field 305 of FIG. 3).

In some embodiments, the wireless management frame is a BSS transition management (BTM) frame.

In some embodiments, the first access point receives a request for a neighbor report from the wireless station.

In some embodiments, the wireless management frame is a neighbor report response frame. In some of these embodiments, first access point receives a request for a neighbor report from the wireless station.

In some embodiments, the neighbor report includes a bit value indicating availability of the BSSID for one or more next epochs.

In some embodiments, the first access point accesses frame anonymization parameter data for the second access point, the frame anonymization data including BSSID information for the one or more next epochs.

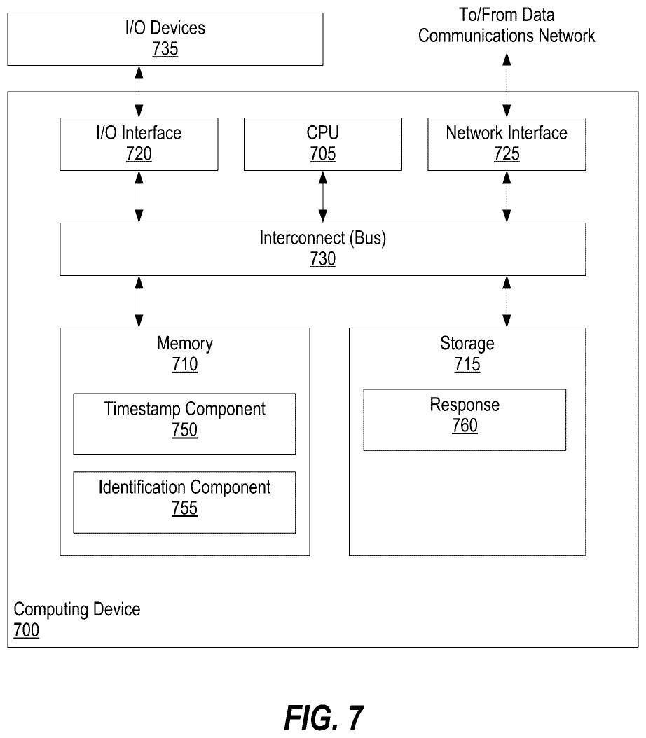

FIG. 7 depicts an example network device 700 configured to perform various aspects of the present disclosure, according to some embodiments of the present disclosure. Although depicted as a physical device, in embodiments, the computing device 700 may be implemented using any number of virtual or physical device(s) (e.g., in a cloud environment). In one embodiment, the computing device 700 corresponds to or implements an AP, such as any of the APs 110 or the AP 210 of FIGS. 1 and 2, respectively, or the APs discussed above with reference to FIGS. 3-6.

As illustrated, the computing device 700 includes a CPU 705, a memory 710, a storage 715, a network interface 725, and one or more I/O interfaces 720. In the illustrated embodiment, the CPU 705 retrieves and executes programming instructions stored in the memory 710, as well as stores and retrieves application data residing in the memory 710, the storage 715, or both. The CPU 705 is generally representative of a single CPU, a single GPU, multiple CPUs, multiple GPUs, a single CPU having multiple processing cores, a single GPU having multiple processing cores, a microcontroller, an application-specific integrated circuit (ASIC), or a programmable logic device (PLD), and the like.

In some embodiments, the I/O devices 735 (such as keyboards, monitors, etc.) are connected via the I/O interface(s) 720. Further, via the network interface 725, the computing device 700 can be communicatively coupled with one or more other devices and components (e.g., via a network, which may include the Internet, local network(s), and the like). As illustrated, the CPU 705, the memory 710, the network interface(s) 725, and the I/O interface(s) 720 are communicatively coupled by one or more buses 730.

The storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 715 may store a variety of data for the efficient functioning of the system.

The memory 710 is generally included to be representative of a random-access memory. The memory 710 may store processor-executable software code containing instructions that, when executed by the CPU 705, enable the computing device 700 to perform various functions described herein for wireless communication. The memory 710 may include random access memory (RAM) and read-only memory (ROM).

As depicted, the memory 710 includes a timestamp component 750 and an identification component 755. Although depicted as discrete components for conceptual clarity, in embodiments, the operations of the depicted components (and others not illustrated) may be combined or distributed across any number of components. Further, although depicted as software residing in the memory 710, in embodiments, the operations of the depicted components (and others not illustrated) may be implemented using hardware, software, or a combination of hardware and software.

The timestamp component 750 may generally correspond, and operate in a similar manner to, the timestamp component 212 of AP 210 of FIG. 2. The timestamp component 750 may be configured to determine epoch(s) associated with neighboring AP(s), representing time(s) at which the neighboring AP will switch to using a new identifier (e.g., BSSID). In some examples, the timestamp component 750 may determine what epoch is, or how many epochs would have passed, at a specific time in the future (e.g., identified by a query, such as the query 205 of FIG. 2, from a STA, such as any of the STAs 115 of FIG. 1 and/or the STA 215 of FIG. 2). In some examples, the timestamp(s) may be relative, such as representing how epochs or how much time passes before a future identifier begins being used by the neighboring AP with respect to a current time, a time starting from the transmission of the response 760 (discussed below), or the like.

The identification component 755 may generally correspond, and operate in a similar manner to, the identification component 213 of AP 210 of FIG. 2. The identification component 755 may be configured to determine one or more future BSSIDs for the neighboring AP device. The identification component 755 may use the epoch information determined by the timestamp component 750 to determine a current BSSID for a neighboring AP, alongside a BSSID for the AP device at a future time (e.g., the time identified by the timestamp component 212). For example, the identification component 755 may apply a hash function to the current BSSID to determine a future BSSID for the AP.

The computing device 700 may generate one or more responses, such as the response 760, to STAs (e.g., any of the STAs 115 or the STA 215 of FIGS. 1 and 2, respectively), providing the STA with information on neighboring APs of the same ESS of the STA. For example, the computing device 700 may transmit the response 760, such as a wireless management frame including a neighbor report element, to the STA, including one or more future BSSIDs (e.g., using the BSSID (Next) field 315 of FIG. 3), as described above. Although depicted as residing in the storage 715, the response 760 of the computing device 700 may be stored in any suitable location.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

1. A method comprising:
implementing, by a first access point, a basic service set (BSS) for one or more wireless stations, wherein:
an Extended Service Set (ESS) includes the first access point and a second access point neighboring the first access point, and
the second access point is a basic service set privacy enhancements (BPE) access point;
encoding, by the first access point, a wireless management frame including a neighbor report element for the second access point, wherein the neighbor report element includes data indicating a basic service set identifier (BSSID) for one or more next epochs; and
transmitting, by the first access point, the wireless management frame to a wireless station of the BSS.

2. The method of claim 1 wherein the neighbor report element includes data indicating a BSSID for a current epoch.

3. The method of claim 1 wherein the wireless management frame is a BSS transition management (BTM) frame.

4. The method of claim 1 further comprising receiving a request for a neighbor report from the wireless station.

5. The method of claim 1 wherein the wireless management frame is a neighbor report response frame.

6. The method of claim 5 further comprising receiving a request for a neighbor report from the wireless station.

7. The method of claim 1 wherein the neighbor report element includes a bit value indicating availability of the BSSID for one or more next epochs.

8. The method of claim 1 further comprising accessing, by the first access point, frame anonymization parameter data for the second access point, the frame anonymization parameter data including BSSID information for the one or more next epochs.

9. An access point comprising:
one or more memories; and
one or more processors communicatively coupled to the one or more memories, wherein the one or more processors are configured to, individually or collectively, perform operations comprising:
implementing, by the access point, a basic service set (BSS) for one or more wireless stations, wherein:
an Extended Service Set (ESS) includes the access point and a second access point neighboring the access point, and
wherein the second access point is a basic service set privacy enhancements (BPE) access point;
encoding, by the access point, a wireless management frame including a neighbor report element for the second access point, wherein the neighbor report element includes data indicating a basic service set identifier (BSSID) for one or more next epochs; and
transmitting, by the access point, the wireless management frame to a wireless station of the BSS.

10. The access point of claim 9 wherein the neighbor report element includes data indicating a BSSID for a current epoch.

11. The access point of claim 9 wherein the wireless management frame is a BSS transition management (BTM) frame.

12. The access point of claim 9, the operations further comprising receiving a request for a neighbor report from the wireless station.

13. The access point of claim 9 wherein the wireless management frame is a neighbor report response frame.

14. The access point of claim 13, the operations further comprising receiving a request for a neighbor report from the wireless station.

15. The access point of claim 9 wherein the neighbor report element includes a bit value indicating availability of the BSSID for one or more next epochs.

16. The access point of claim 9, the operations further comprising accessing, by the access point, frame anonymization parameter data for the second access point, the frame anonymization parameter data including BSSID information for the one or more next epochs.

17. A non-transitory computer readable storage medium comprising instructions that when executed configure one or more processors of an access point to perform operations comprising:
implementing, by the access point, a basic service set (BSS) for one or more wireless stations, wherein:
an Extended Service Set (ESS) includes the access point and a second access point neighboring the access point, and
wherein the second access point is a basic service set privacy enhancements (BPE) access point;
encoding, by the access point, a wireless management frame including a neighbor report element for the second access point, wherein the neighbor report element includes data indicating a basic service set identifier (BSSID) for one or more next epochs; and
transmitting, by the access point, the wireless management frame to a wireless station of the BSS.

18. The non-transitory computer readable storage medium of claim 17 wherein the neighbor report element includes data indicating a BSSID for a current epoch.

19. The non-transitory computer readable storage medium of claim 17 wherein the wireless management frame is a BSS transition management (BTM) frame.

20. The non-transitory computer readable storage medium of claim 17, the operations further comprising receiving a request for a neighbor report from the wireless station.

21. The non-transitory computer readable storage medium of claim 17 wherein the wireless management frame is a neighbor report response frame.

22. The non-transitory computer readable storage medium of claim 21, the operations further comprising receiving a request for a neighbor report from the wireless station.

23. The non-transitory computer readable storage medium of claim 17 wherein the neighbor report element includes a bit value indicating availability of the BSSID for one or more next epochs.

24. The non-transitory computer readable storage medium of claim 17, the operations further comprising accessing, by the access point, frame anonymization parameter data for the second access point, the frame anonymization parameter data including BSSID information for the one or more next epochs.
